(19) United States
(12) Patent Application Publication
(10) Pub. No.: US 2021/0189304 A1
(43) Pub. Date: Jun. 24, 2021

(54) Delivery System For Dryer Balls

(71) Applicant: Henkel IP & Holding GmbH, Duesseldorf (DE)

(72) Inventors: Maxime Pelletier, Trumbull, CT (US); Jody Mihalek, Shelton, CT (US); John W. Marchese, Trumbull, CT (US)

(73) Assignee: Henkel IP & Holding GmbH, Duesseldorf (DE)

(21) Appl. No.: 17/127,564

(22) Filed: Dec. 18, 2020

Related U.S. Application Data
(60) Provisional application No. 62/950,389, filed on Dec. 19, 2019.

(51) Int. Cl. C11D 17/04; C11D 3/00; C11D 3/50; C11D 3/42; C11D 3/48; C11D 17/00; C11D 3/30; C11D 3/37

(52) U.S. Cl. CPC C11D 17/047; C11D 3/001; C11D 3/505; C11D 3/0068; C11D 3/0021; C11D 3/373; C11D 3/42; C11D 3/48; C11D 17/003; C11D 17/0039; C11D 3/30; C11D 3/0036

(57) ABSTRACT

Provided herein are devices for treating a fabric or textile, kits including devices for treating a fabric or textile, and methods of making and using the same.

### FIELD OF THE INVENTION

The present disclosure relates to devices for treating textiles. More specifically, the present disclosure relates to wraps comprising a treatment agent to be disposed around dryer balls.

### BACKGROUND OF THE INVENTION

Dryer balls, e.g., wool, plastic, or rubber dryer balls which accompany wet laundry into the dryer, and tumble freely in the dryer drum with the washed fabrics, are commercially available for use as an alternative to dryer sheets. Some consumers choose to dry laundry with dryer balls as a way to shorten drying time of a load of laundry in a dryer, and/or provide fluffing to fabrics. However, following drying, consumers often want their laundry not only to feel sufficiently dry, but also to have additional benefits. For example, consumers may prefer that the dried fabrics feel soft, smell pleasant, and/or are free of static. Currently available dryer balls do not provide such additional benefits.

Similarly, currently available dryer sheets suffer from drawbacks. For example, disposable fabric softener sheets are discarded after one drying cycle, and some consumers may prefer a softening and/or anti-static product that can be used more than once. Further, consumers may desire that the dryer sheets, which typically have the benefits of static removal, fragrance, and/or softening.

Accordingly, a need exists for improved devices and methods for providing the aforementioned benefits and additional benefits of less waste and being more environmentally friendly to a laundry device for use in a dryer.

### BRIEF SUMMARY OF THE INVENTION

In some embodiments, a device for treating textiles in a dryer includes a ball and a wrap disposed around an exterior surface of the ball. In some embodiments, the wrap is treated with a treatment agent. In some embodiments, the wrap covers at least 10% of the exterior surface of the ball. In some embodiments, the wrap covers at least 30% of the exterior surface of the ball. In some embodiments, the wrap covers at least 50% of the exterior surface of the ball.

In some embodiments, the wrap is releasably attached to the exterior surface of the ball. In some embodiments, the wrap has a first surface and a second surface opposite the first surface, and the first surface is configured to contact the exterior surface of the ball. In some embodiments, at least a portion of the first surface is configured to mate with the exterior surface of the ball. In some embodiments, the wrap is configured to be detached from the ball after one or more cycles (i.e., multi-uses) in the dryer.

In some embodiments, the ball comprises wool. In some embodiments, the ball comprises plastic. In some embodiments, the ball comprises rubber. In some embodiments, the ball is spherical. In some embodiments, the ball is oblong.

In some embodiments, a wrap for treating textiles in a dryer comprises a substrate configured to be disposed around a dryer ball and a treatment agent disposed on the substrate. In some embodiments, the substrate comprises an elastic material. In some embodiments, the substrate is a woven material. In some embodiments, the substrate comprises cotton, wool, polyester, nylon, elastane, rayon, acetate, acrylic, natural fibers, synthetic fibers, or combinations thereof.

In some embodiments, the substrate has a width of about 1 cm to about 15 cm. In some embodiments, the substrate has a thickness of about 0.1 cm to about 1 cm.

In some embodiments, the substrate is a continuous band. In some embodiments, the substrate has a circumference of about 5 cm to about 50 cm.

In some embodiments, the substrate includes a first end and a second end, and the first end and the second end are configured to be releasably attached. In some embodiments, the first end comprises a hook portion and the second end comprises a loop portion of a hook-and-loop fastener.

In some embodiments, the treatment agent is a liquid treatment agent. In some embodiments, the treatment agent is a gel treatment agent. In some embodiments, the treatment agent is encapsulated in a microcapsule, a nanocapsule, or any combination thereof.

In some embodiments, the wrap includes an indicator configured to indicate that less than 100% of the treatment agent is remaining. In some embodiments, the indicator is configured to indicate that less than about 90%, less than about 80%, less than about 70%, less than about 60%, less than about 50%, less than about 40%, less than about 30%, less than about 20%, or less than about 10%, of the treatment agent is remaining. In some embodiments, the indicator is attached to the substrate. In other embodiments, the indicator is integrated into the substrate.

In some embodiments, the treatment agent is disposed on the second surface of the wrap.

In some embodiments, the treatment agent includes a fragrance, a softening agent, an anti-static agent, or any combination thereof.

In some embodiments, the treatment agent melts at a temperature of between about 35° C. to about 75° C.

In some embodiments, the fragrance is a fragrance precursor, a free fragrance, an encapsulated fragrance, or a non-encapsulated fragrance. In some embodiments, the fragrance is an ester, an ether, an aldehyde, a ketone, an alcohol, a hydrocarbon, an oil, an essential oil, a botanical, or any combination thereof. In some embodiments, the fragrance is in an amount of from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the softening agent is a quaternary ammonium compound. In some embodiments, the quaternary ammonium compound is selected from the group consisting of: alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof. In some embodiments, the quaternary ammonium compound is in an amount of from about 0.5 g to about 5.0 g, or from about 1.0 g to about 5.0 g, or from about 1 g to about 4.5 g, or from about 2 g to about 4.5 g, or from about 3 g to about 5 g, or from about 3 g to about 4.5 g, based on the total weight of the band.

In some embodiments, the softening agent is a silicone. In some embodiments, the silicone is selected from the group consisting of: polydialkylsiloxanes, amino functionalised silicones, and anionic silicones. In some embodiments, the silicone is in an amount of from about 0.5 g to about 5.0 g, or from about 1.0 g to about 5.0 g, or from about 1 g to about 4.5 g, or from about 2 g to about 4.5 g, or from about 3 g to about 5 g, or from about 3 g to about 4.5 g, based on the total weight of the band.

In some embodiments, the anti-static agent is a quaternary ammonium compound. In some embodiments, the anti-static quaternary ammonium compound is selected from the group consisting of: alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof. In some embodiments, the anti-static quaternary ammonium compound is in an amount of from about 0.5 g to about 5.0 g, or from about 1.0 g to about 5.0 g, or from about 1 g to about 4.5 g, or from about 2 g to about 4.5 g, or from about 3 g to about 5 g, or from about 3 g to about 4.5 g, based on the total weight of the band.

In some embodiments, the wrap includes an additional treatment agent. In some embodiments, the treatment agent further includes at least one additional agent selected from the group consisting of: an anti-wrinkling agent, an odor capturing agent, a fiber protection agent, a color protection agent, a soil releasing agent, an optical brightening agent, a UV protection agent, an anti-pilling agent, a water repellency agent, a disinfecting and/or sanitizing agent, a souring agent, a repellent, and mixtures thereof. In some embodiments, the at least one additional agent is in an amount of from about 0.5 g to about 5.0 g, based on the total weight of the band.

In some embodiments, a kit includes one or more dryer balls and one or more wraps configured to be disposed around the one or more dryer balls. In some embodiments, the one or more wraps are treated with a first treatment agent. In some embodiments, the kit includes a container confining a volume of a second treatment agent for disposing on the one or more wraps. In some embodiments, the second treatment agent is different than the first treatment agent.

In some embodiments, a method of making a wrap for treating textiles in a dryer includes providing a substrate configured to be disposed around a dryer ball and disposing a treatment agent on the substrate. In some embodiments, disposing the treatment agent on the substrate includes soaking the substrate in the treatment agent for a period of time to saturate the substrate with the treatment agent. In some embodiments, disposing the treatment agent on the substrate includes spraying the treatment agent on the substrate. In some embodiments, the method further includes drying the substrate. In some embodiments, the substrate is dried at a temperature in the range of about 20° C. to about 90° C.

In some embodiments, a method for treating a textile in a dryer includes disposing a wrap around a dryer ball, where the wrap is treated with a treatment agent. In some embodiments, disposing the wrap around the dryer ball includes stretching the wrap to fit around the dryer ball. In some embodiments, disposing the wrap around the dryer ball includes attaching a first end of the wrap to a second end of the wrap. In some embodiments, the method includes loading the dryer ball and wrap into the dryer. In some embodiments, the method includes running the dryer.

### BRIEF DESCRIPTION OF THE DRAWINGS

FIG. 1 illustrates a ball with a wrap according to an embodiment.

FIG. 2 illustrates a wrap according to an embodiment.

FIG. 3 illustrates a wrap according to an embodiment.

FIG. 4A illustrates a ball.

FIG. 4B illustrates a ball with a wrap according to an embodiment.

FIG. 5 is a graph showing the anti-static efficacy results of disclosed devices on fabric samples according to embodiments. The X-axis indicates the prototype tested. The Y-axis is the change in μC.

FIG. 6 is a graph showing the electrical static field in the dryer phase of testing disclosed devices on fabric samples according to embodiments. of the invention. The X-axis indicates the time in seconds. The Y-axis is the static charge.

### DETAILED DESCRIPTION OF THE INVENTION

### Definitions

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Open terms such as “include,” “including,” “contain,” “containing,” and the like mean “comprising.”

The act of treating a textile can refer to, for example, one or more of: i) softening a textile; ii) applying a perfume to a textile; iii) applying a perfume to and softening a textile; iv) rendering the textile resistant to static build up during drying; or any combination thereof.

The term “or” can be conjunctive or disjunctive.

Some inventive embodiments contemplate numerical ranges. Every numerical range provided herein includes the range endpoints as individual inventive embodiments. When a numerical range is provided, all individual values and sub-ranges therein are present as if explicitly written out.

The terms “textile” and “fabric” can be used interchangeably.

The terms “fragrance” and “perfume” can be used interchangeably.

The term “about” is synonymous with the term “approximately,” and includes the recited number±10% or ±5%. For example, “about 10” means 9 to 11. Also as an example, a temperature of approximately 50° C. means 45-55° C., or 47.5° C.-52.5° C. Unless indicated otherwise, all percentages indicated are percentage by weight.

The term “at least one,” refers to one or more, for example 1, 2, 3, 4, 5, 6, 7, 8, 9 or more. In particular, this information refers to the type of agent/compound and not to the absolute number of molecules. “At least one fragrance” therefore means that at least one type of fragrance is included, but that two or more different types of fragrances may also be included.

The term “wrap” refers to a substrate (i.e., a piece of material) which can be disposed around a dryer ball. The terms “wrap,” “band,” and “substrate” can be used interchangeably.

### EMBODIMENTS

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

### Dryer Ball Device

As described herein, there is a need for an improved device for providing benefits to laundry for use in a dryer that overcomes the drawbacks of currently available devices and methods. According to various embodiments described herein, the devices described herein provide advantages over the prior art by providing a simple and ecological way to impart one or more benefits to fabrics during a drying cycle. In particular, a number of benefits can be provided to laundry via the re-usable devices described herein. In embodiments, the consumer can choose the preferred combination of benefits. Such benefits include, but are not limited to: shortened drying time, fluffing of fabrics, softness, fragrance, and static lessening/removal.

In embodiments, the treatment agent includes a fragrance, a softening agent, an anti-static agent, or combinations thereof, as discussed below.

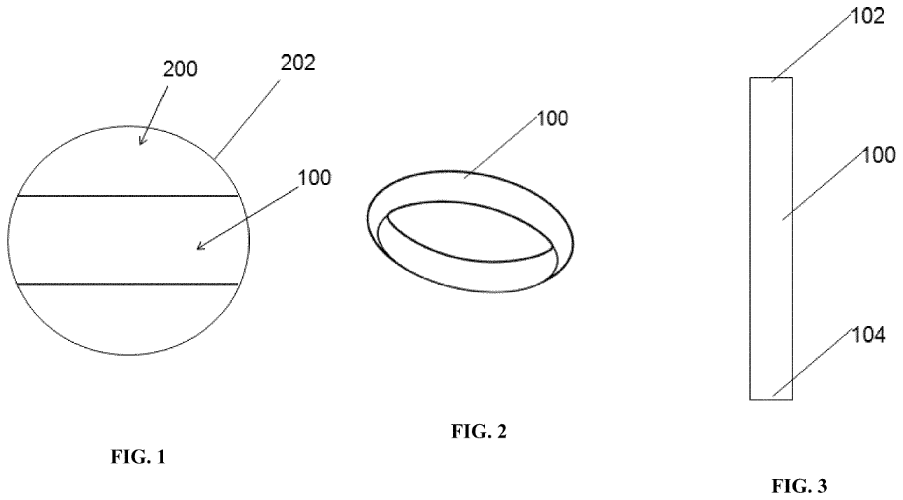

Embodiments will now be described in more detail with reference to the Figures With reference to FIGS. 1-3, for example, in some embodiments, the device provided herein includes a ball 200, and a wrap 100. As shown, in some embodiments, the wrap 100 is disposed around an exterior surface 202 of the ball 200. In some embodiments, the wrap 100 is treated with a treatment agent, described herein. In some embodiments, the wrap is a continuous band, as shown, for example in FIG. 2. In some embodiments, as shown, for example in FIG. 3, the wrap 100 has a first end 102 and a second end 104 such that the first end and the second end are configured to be releasably attached. In some embodiments, the wrap 100 is releasably attached to the exterior surface 202 of the ball 200. In some embodiments, the wrap 100 is configured to be detached from the ball 200 after one or more cycles in the dryer.

The wrap 100 can be different shapes and sizes, such that it covers more or less of the exterior surface 202 of the ball 200. In one embodiment the wrap 100 covers at least 10% of the exterior surface 202 of the ball 200. In another embodiment, the wrap 100 covers at least 30% of the exterior surface 202 of the ball 200. In another embodiment, the wrap 100 covers at least 50% of the exterior surface 202 of the ball 200.

In some embodiments, the wrap 100 has a first surface and a second surface opposite the first surface, where the first surface is configured to contact the exterior surface 202 of the ball 200. In some embodiments, at least a portion of the first surface is configured to mate with the exterior surface 202 of the ball 200. For example, in some embodiments, all or a portion of the first surface may include an adhesive configured to secure the wrap 100 to the exterior surface 202 of the ball 200. In some embodiments, all or a portion of the first surface may include one side of a hook-and-loop fastener (e.g., the hook portion or loop portion). For example, the first surface may include the hook portion, which may mate with the exterior surface 202 of the ball 200, for example, a wool ball.

As discussed in more detail below, in some embodiments, one or more treatment agent is disposed on the wrap 100. The treatment agent may be disposed on the first surface of the wrap, the second surface of the wrap, or both. In some embodiments, the entire thickness of the wrap includes the treatment agent(s) and not just the exterior surface(s). For example, the wrap 100 may be impregnated with the treatment agent throughout the material of the wrap.

The ball 200, for example a dryer ball, can be a variety of shapes, sizes, and material. In some embodiments, the ball is wool. In some embodiments, the ball is plastic. In some embodiments, the ball is rubber. In one embodiment, the ball is spherical. In another embodiment, the ball is oblong. In one embodiment, the ball comprises protrusions. Other shapes, sizes, and materials are contemplated.

### Wrap for Treating Textiles

In some embodiments, a wrap 100 for treating textiles in a dryer includes a substrate configured to be disposed around a dryer ball and a treatment agent disposed on the substrate.

The treatment agent may be a fragrance, a softening agent, an anti-static agent, or any combination thereof. Examples of treatment agents are described in detail herein.

The substrate may be made from one or more materials. In some embodiments, the substrate can be an elastic material or include one more elastic materials. In some embodiments, the substrate can be a woven material. By way of example, the substrate can include cotton, wool, polyester, nylon, elastane, rayon, acetate, acrylic, natural fibers, synthetic fibers, or combinations thereof.

The substrate may also be various shapes and sizes. In some embodiments, the substrate has a length (i.e., vertical direction in FIG. 3) of about 5 cm to about 100 cm. In some embodiments, the substrate has a length of about 10 cm to about 50 cm. In some embodiments, the substrate has a width (i.e., horizontal direction in FIG. 3) of about 1 cm to about 15 cm. In some embodiments, the substrate has a width (i.e., horizontal direction in FIG. 3) of about 5 cm to about 10 cm. In some embodiments, the substrate has a thickness (i.e., distance from exterior surface of the ball) of about 0.1 cm to about 1 cm. In some embodiments, the substrate is a continuous band (e.g., FIG. 2). In another embodiment, the substrate has a circumference of about 5 cm to about 50 cm. In another embodiment, the substrate has a circumference of about 10 cm to about 30 cm.

In some embodiments, the substrate 100 has a first end 102 and a second end 104, with the first end 102 and the second end 104 being configured to be releasably attached (e.g., FIG. 3). For example, in some embodiments, the first end 102 may include a hook portion and the second end 104 may include a loop portion of a hook-and-loop fastener such that the first and second ends may be secured together such that the substrate forms a circular band. Other fastening mechanisms may be used to secure first end 102 with second end 104, for example, but not limited to adhesives, clips, snaps, buttons, clasps, and the like.

In some embodiments, the wrap 100 includes an indicator configured to indicate that less than 100% of the treatment agent is remaining. For example, the indicator may be configured to indicate that less than about 90%, less than about 80%, less than about 70%, less than about 60%, less than about 50%, less than about 40%, less than about 30%, less than about 20%, or less than about 10%, of the treatment agent is remaining. This may help a user to know how much treatment agent is remaining so that they may purchase a new wrap before the treatment agent is used up. In some embodiments, the indicator is attached to the substrate. In some embodiments, the indicator is integral with the substrate. In some embodiments, the indicator may be a color-changing or fading indicator.

### Treatment Agent(s)

The treatment agents described herein can be used, for example, in the drying cycle of a laundry or fabric cleaning method to provide softening or other benefits to fabrics. Other benefits includes, but are not limited to fragrance, static-lessening, or combinations thereof. Kits comprising a ball and a wrap for treating a fabric or textile comprising the treatment agents disclosed herein are further subjects of this application.

In some embodiments, the treatment agent is for disposal on the substrate. In one embodiment, the treatment agent is a liquid treatment agent. In another embodiment, the treatment agent is a gel treatment agent. In another embodiment, the treatment agent is encapsulated in a microcapsule, a nanocapsule, or any combination thereof.

In embodiments, the treatment agent of the present disclosure may include some or all of the ingredients listed below.

### Fragrance(s)

In some embodiments, the treatment agent for fabric treatment contains one or more free fragrances.

In some embodiments, the fragrance can be a fragrance precursor, a free fragrance, an encapsulated fragrance, or a non-encapsulated fragrance.

In some embodiments, the fragrance can be an ester, an ether, an aldehyde, a ketone, an alcohol, a hydrocarbon, an essential oil, and a combination thereof.

In some embodiments, the fragrance can be, for example, adoxal (2,6,10-trimethyl-9-undecenal), anisaldehyde (4-methoxybenzaldehyde), cymal (3-(4-isopropyl-phenyl)-2-methylpropanal), ethylvanillin, florhydral (3-(3-isopropylphenyl)butanal), helional (3-(3,4-methylenedioxyphenyl)-2-methylpropanal), heliotropin, hydroxycitronellal, lauraldehyde, lyral (3- and 4-(4-hydroxy-4-methylpentyl)-3-cyclohexene-1-carboxaldehyde), methyl nonyl acetaldehyde, lilial (3-(4-tert-butylphenyl)-2-methylpropanal), phenyl acetaldehyde, undecylenaldehyde, vanillin, 2,6,10-trimethyl-9-undecenal, 3-dodecen-1-al, alpha-n-amylcinnamaldehyde, melonal (2,6-dimethyl-5-heptenal), 2,4-dimethyl-3-cyclohexene-1-carboxaldehyde (triplal), 4-methoxybenzaldehyde, benzaldehyde, 3-(4-tert-butylphenyl)propanal, 2-methyl-3-(para-methoxyphenyl)propanal, 2-methyl-4-(2,6,6-timethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzyl aldehyde, 1,2,3,4,5,6,7,8-octahydro-8,8-dimethyl-2-naphthaldehyde, 2,4-dimethyl-3-cyclohex ene-1-carboxaldehyde, 2-methyl-3-(isopropylphenyl)propanal, 1-decanal, 2,6-dimethyl-5-heptenal, 4-(tricyclo[5.2.1.0(2,6)]decylidene-8)butanal, octahydro-4,7-methano-1H-indenecarboxaldehyde, 3-ethoxy-4-hydroxybenzaldehyde, para-ethyl-alpha,alpha-dimethylhydrocinnamaldehyde, alpha-methyl-3,4-(methylenedioxy)hydrocinnamaldehyde, 3,4-methylenedioxybenzaldehyde, alpha-n-hexylcinnamaldehyde, m-cymene-7-carboxaldehyde, alpha-methyl phenylacetaldehyde, 7-hydroxy-3,7-dimethyloctanal, undecanal, 2,4,6-trimethyl-3-cyclohexene-1-carboxaldehyde, 4-(3)(4-methyl-3-pentenyl)-3-cyclohexenecarboxaldehyde, 1-dodecanal, 2,4-dimethylcyclohexene-3-carboxaldehyde, 4-(4-hydroxy-4-methylpentyl)-3-cyclohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methanoindane-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3,7-dimethyloctanal, trans-4-decenal, 2,6-nonadienal, para-tolylacetaldehyde, 4-methyl phenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3,7-dimethyl-2-methyl ene-6-octenal, phenoxyacetaldehyde, 5,9-dimethyl-4,8-decadienal, peony aldehyde (6,10-dimethyl-3-oxa-5,9-undecadien-1-al), hexahydro-4,7-methanoindane-1-carboxaldehyde, 2-methyloctanal, alpha-methyl-4-(1-methylethyl)benzene acetaldehyde, 6,6-dimethyl-2-norpinene-2-propionaldehyde, para-methylphenoxy acetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methyl nonyl acetaldehyde, hexanal and trans-2-hexenal.

In some embodiments, the fragrance can be, for example, methyl beta-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), alpha-damascone, beta-damascone, delta-damascone, iso-damascone, damascenone, methyl dihydrojasmonate, menthone, carvone, camphor, koavone (3,4,5,6,6-pentamethylhept-3-en-2-one), fenchone, alpha-ionone, beta-ionone, gamma-methyl ionone, fleuramone (2-heptylcyclopentanone), dihydrojasmone, cis-jasmone, Iso E Super (1-(1,2,3,4,5,6J,8-octahydro-2,3,8,8-tetramethyl-2-naphthalenyl)ethan-1-one (and isomers)), methyl cedrenyl ketone, acetophenone, methyl acetophenone, para-methoxyacetophenone, methyl beta-naphtyl ketone, benzyl acetone, benzophenone, para-hydroxyphenylbutanone, celery ketone (3-methyl-5-propyl-2-cyclohexenone), 6-isopropyl decahydro-2-naphthone, dimethyl octenone, frescomenthe (2-butan-2-yl cyclohexan-1-one), 4-(1-ethoxyvinyl)-3,3,5,5-tetramethyl cyclohexanone, methyl heptenone, 2-(2-(4-methyl-3-cyclohexen-1-yl)propyl)cyclopentanone, 1-(p-menthen-6(2)yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)indanone, 4-damascol, dulcinyl(4-(1,3-benzodioxol-5-yl)butan-2-one), Hexalon (1-(2,6,6-trimethyl-2-cyclohexen-1-yl)-1,6-heptadien-3-one), isocyclemone E (2-acetonaphthone-1,2,3,4,5,6,7,8-octahydro-2,3,8,8-tetramethyl), methyl nonyl ketone, methyl cyclocitrone, methyl lavender ketone, orivone (4-tert-amylcyclohexanone), 4-tert-butylcyclohexanone, delphone (2-pentyl cyclopentanone), muscone (CAS 541-91-3), neobutenone (1-(5,5-dimethyl-1-cyclohexenyl)pent-4-en-1-one), plicatone (CAS 41724-19-0), veloutone (2,2,5-trimethyl-5-pentylcyclopentan-1-one), 2,4,4,7-tetramethyloct-6-en-3-one and tetrameran (6,10-dimethylundecen-2-one).

In some embodiments, the fragrance can be, for example, 10-undecen-1-ol, 2,6-dimethylheptan-2-ol, 2-methylbutanol, 2-methylpentanol, 2-phenoxyethanol, 2-phenylpropanol, 2-tert-butylcyclohexanol, 3,5,5-trimethylcyclohexanol, 3-hexanol, 3-methyl-5-phenylpentanol, 3-octanol, 3-phenylpropanol, 4-heptenol, 4-isopropylcyclohexanol, 4-tert-butylcyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, β-terpineol, butyl salicylate, citronellol, cyclohexyl salicylate, decanol, dihydromyrcenol, dimethyl benzyl carbinol, dimethyl heptanol, dimethyloctanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylat, tetrahydrogeraniol, tetrahydrolinalool, thymol, trans-2-cis-6-nonadicnol, trans-2-nonen-1-ol, trans-2-octenol, undecanol, vanillin, champiniol, hexenol and cinnamyl alcohol.

In some embodiments, the fragrance can be, for example, for example, benzyl acetate, phenoxyethyl isobutyrate, p-tert-butylcyclohexyl acetate, linalyl acetate, dimethyl benzyl carbinyl acetate (DMBCA), phenyl ethyl acetate, benzyl acetate, ethylmethylphenyl glycinate, allyl cyclohexyl propionate, styralyl propionate, benzyl salicylate, cyclohexyl salicylate, floramat, melusat and jasmacyclat.

In one embodiment, the fragrance can be, for example, for example, benzyl ethyl ether and ambroxan. The hydrocarbons include mainly terpenes, such as limonene and pinene.

In some embodiments, the fragrance can be mixtures of various fragrances, which can be referred to as a perfume or perfume oil. Perfume oils of this kind may also contain natural fragrance mixtures, as are obtainable from plant sources.

In some embodiments, the fragrance can be, for example, essential oils such as angelica root oil, anise oil, arnica blossom oil, basil oil, bay oil, champaca blossom oil, citrus oil, silver fir oil, silver fir cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, canaga oil, cardamom oil, cassia oil, pine needle oil, copaiba balsam oil, coriander oil, spearmint oil, caraway oil, cumin oil, labdanum oil, lavender oil, lemongrass oil, lime blossom oil, lime oil, mandarin oil, balm oil, mint oil, musk seed oil, muscatel oil, myrrh oil, clove oil, neroli oil, niaouli oil, olibanum oil, orange blossom oil, orange oil, origanum oil, palmarosa oil, patchouli oil, peru balsam oil, petitgrain oil, pepper oil, peppermint oil, pimento oil, pine oil, rose oil, rosemary oil, sage oil, sandalwood oil, celery oil, spike oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil and ambrettolide, ambroxan, alpha-amylcinnamaldehyde, anethol, anisaldehyde, anise alcohol, anisol, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, alpha-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptine carboxylic acid methyl ester, heptaldehyde, hydroquinone dimethyl ether, hydroxycinnamaldehyde, hydroxycinnamyl alcohol, indol, irone, isoeugenol, isoeugenol methyl ether, isosafrole, jasmone, camphor, carvacrol, carvone, p-cresol methyl ether, cumarin, p-methoxyacetophenone, methyl n-amyl ketone, methyl anthranilic acid methyl ester, p-methyl acetophenone, methyl chavicol, p-methyl quinoline, methyl beta-naphthyl ketone, methyl n-nonyl acetaldehyde, methyl n-nonyl ketone, muscone, beta-naphthol ethyl ether, beta-naphthol methyl ether, nerol, n-nonyl aldehyde, nonyl alcohol, n-octyl aldehyde, p-oxy-acetophenone, pentadecanolide, beta-phenyl ethyl alcohol, phenyl acetic acid, pulegone, safrole, salicylic acid isoamyl ester, salicylic acid methyl ester, salicylic acid hexyl ester, salicylic acid cyclohexyl ester, santalol, sandelice, skatole, terpineol, thymene, thymol, troenan, gamma-undelactone, vanillin, veratrum aldehyde, cinnmaldehyde, cinnamyl alcohol, cinnamic acid, cinnamic acid ethyl ester, cinnamic acid benzyl ester, diphenyl oxide, limonene, linalool, linalyl acetate and propionate, melusat, menthol, menthone, methyl n-heptenone, pinene, phenylacetaldehyde, terpinyl acetate, citral, citronellal, and mixtures thereof.

In some embodiments, the fragrance can have, for example, a musky scent, a pungent scent, a camphoraceous scent, an ethereal scent, a floral scent, a peppermint scent, or any combination thereof.

In some embodiments, the fragrance can be methyl formate, methyl acetate, methyl butyrate, ethyl butyrate, isoamyl acetate, pentyl butyrate, pentyl pentanoate, octyl acetate, myrcene, geraniol, nerol, citral, citronellol, linalool, nerolidol, limonene, camphor, terpineol, alpha-ionone, thujone, benzaldehyde, eugenol, cinnamaldehyde, ethyl maltol, vanillin, anisole, anethole, estragole, thymol, indole, pyridine, furaneol, 1-hexanol, cis-3-hexenal, furfural, hexyl cinnamaldehyde, fructone, hexyl acetate, ethyl methyl phenyl glycidate, dihydrojasmone, oct-1-en-3-one, 2-acetyl-1-pyrroline, 6-acetyl-2,3,4,5-tetrahydropyridine, gamma-decalactone, gamma-nonalactone, delta-octalone, jasmine lactone, massoia lactone, wine lactone, sotolon, grapefruit mercaptan, methanthiol, methyl phosphine, dimethyl phosphine, nerolin, 2,4,6-trichloroanisole, or any combination thereof.

In some embodiments, the fragrance can be a linear terpene, a cyclic terpene, an aromatic compound, a lactone, a thiol, or any combination thereof.

Other art-known fragrances, or any fragrance commercially available from a fragrance supplier (for example, Firmenich, Givaudan, International Flavors and Fragrances (IFF), Oriental etc.), or combinations of such fragrances, may also suitably be used in the treatment agents and methods disclosed herein.

In some embodiments, the fragrance can be a fragrance precursor. “Fragrance precursor” refers to compounds which only release the actual fragrance following chemical conversion/separation, for example, when exposed to light or other environmental conditions, such as pH, temperature, etc. Treatment agents of this kind are often referred to as pro-fragrances.

In some embodiments, at least some of the fragrance can be encapsulated, for example, in a microcapsule or a nanocapsule. The microcapsules and nanocapsules can be water-soluble or water-insoluble. In one embodiment, all of the fragrance is encapsulated. Examples of encapsulated fragrances are described in, for example, U.S. Pat. Nos. 6,024,943, 6,056,949, 6,194,375, 6,458,754 and 8,426,353, and US 2011/0224127 A1, each of which is incorporated by reference in its entirety.

In some embodiments, the fragrance is present in the treatment agent from about 0.1 wt % to about 20 wt %, or from about 0.5 wt % to about 20 wt %, or from about 0.5 wt % to about 15 wt %, or from about 1 wt % to about 15 wt %, based on the volume of the treatment agent.

In some embodiments, the fragrance is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

### Softening Agent(s)

In some embodiments, the treatment agent for fabric treatment can include a softening agent.

### Quaternary Ammonium Compounds

In some embodiments, the softening agent can be a quaternary ammonium compound.

In some embodiments, suitable quaternary ammonium compounds can be alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds monoester quats, diester quats (“DEQ”), triester quats and combinations thereof.

In some embodiments, suitable quaternary ammonium compounds can be: esters of bis-(2-hydroxypropyl)-dimethylammonium methyl sulfate, isomers of esters of bis-(2-hydroxypropyl)-dimethylammonium methylsulfate and fatty acid, N,N-bis-(stearoyl-2-hydroxypropyl)-N,N-dimethylammonium methylsulfate, esters of bis-(2-hydroxypropyl)-dimethylammonium methylsulfate, isomers of esters of bis-(2-hydroxypropyl)-dimethylammonium methylsulfate, esters of N,N-bis(hydroxyethyl)-N,N-dimethyl ammonium chloride, N,N-bis(stearoyl-oxy-ethyl)-N,N-dimethyl ammonium chloride, esters of N,N,N-tri(2-hydroxyethyl)-N-methyl ammonium methylsulfate, N,N-bis-(palmitoyl-2-hydroxypropyl)-N,N-dimethylammoniu methyl sulfate, N,N-bis-(stearoyl-2-hydroxypropyl)-N,N-dimethylammonium chloride, 1,2-di-(stearoyl-oxy)-3-trimethylammoniumpropane chloride, dicanoladimethylammonium chloride, di(hard)tallowdimethylammonium chloride, dicanoladimethylammonium methyl sulfate, 1-methyl-1-stearoylamidoethyl-2-stearoylimidazolinium methylsulfate, imidazoline quat: 1-tallowylamidoethyl-2-tallowylimidazoline, dipalmitoylmethyl hydroxyethylammonium methylsulfate, dipalmylmethyl hydroxyethylammoinum methyl sulfate, 1,2-di(acyloxy)-3-trimethyl ammoniopropane chloride, and mixtures thereof.

In some embodiments, quaternary ammonium compounds can be: ammonium compounds having an alkyl group containing between 6 and 24 carbon atoms. Additional suitable alkylated quaternary alkylated quaternary ammonium compounds include but are not limited to: monoalkyl trimethyl quaternary ammonium compounds, monomethyl trialkyl quaternary ammonium compounds, and dialkyl dimethyl quaternary ammonium compounds. Suitable commercially available compounds are Adogen™, Arosurf®, Variquat®, and Varisoft® (alkylated quaternary ammonium compounds). The alkyl group can be a C₈-C₂₂ group or a C₈-C₁₈ group or a C₁₂-C₂₂ group that is aliphatic and saturated or unsaturated or straight or branched, an alkyl group, a benzyl group, an alkyl ether propyl group, hydrogenated-tallow group, coco group, stearyl group, palmityl group, and soya group. Suitable compounds are commercially available under names Variquat®. and Varisoft® (aromatic quaternary ammonium compounds).

In some embodiments, cyclic quaternary ammonium compounds can be: imidazolinium quaternary ammonium compounds include methyl-1hydr. tallow amido ethyl-2-hydr. tallow imidazolinium-methyl sulfate, methyl-1-tallow amido ethyl-2-tallow imidazolinium-methyl sulfate, methyl-1-oleyl amido ethyl-2-oleyl imidazolinium-methyl sulfate, and 1-ethylene bis (2-tallow, 1-methyl, imidazolinium-methyl sulfate). Suitable aromatic quaternary ammonium compounds include those compounds that have at least one benzene ring in the structure, included but not limited to: aromatic quaternary ammonium compounds include dimethyl alkyl benzyl quaternary ammonium compounds, monomethyl dialkyl benzyl quaternary ammonium compounds, trimethyl benzyl quaternary ammonium compounds, and trialkyl benzyl quaternary ammonium compounds. The alkyl group can contain between about 6 and about 24 carbon atoms, and can contain between about 10 and about 18 carbon atoms, and can be a stearyl group or a hydrogenated tallow group In some embodiments, the aromatic quaternary ammonium compounds can include multiple benzyl groups.

In some embodiments, the quaternary ammonium compound can be diquaternary ammonium compounds, e.g., having at least two quaternary ammonium groups. A suitable compound is available under the name Adogen 477 (N-tallow pentamethyl propane diammonium dichloride).

In some embodiments, the quaternary ammonium compound can be amidoamine quaternary ammonium compounds. Suitable compounds are commercially available under the name Varisoft® (diamidoamine quaternary ammonium compounds). In an embodiment, the amidoamine quaternary ammonium compound can include but is not limited to: methyl-bis(tallow amidoethyl)-2-hydroxy ethyl ammonium methyl sulfate, methyl bis (oleylamidoethyl)-2-hydroxyethyl ammonium methyl sulfate, and methyl bis (hydr.tallowamidoethyl)-2-hydroxyethyl ammonium methyl sulfate. Suitable compounds are commercially available under the name Stepantex™ (ester quaternary compounds).

In some embodiments, to maintain odor stability of a liquid agent while improving processability of the quaternary ammonium compound, the iodine value (IV) of the parent fatty acyl compound or acid from which the alkyl or, alkenyl chains are derived is from 0 to 60, preferably from 12 to 58, more preferably from 18 to 56.

Suitable commercially available salts are available from Witco Corporation under the trade name Adogen™ 472 (dialkylenedimethylammonium salts and dioleyldimethylammonium chloride) and dihardtallow dimethylammonium chloride available from Akzo Nobel under the name Arquad® 2HT75 (dihardtallow dimethylammonium chloride).

Quaternary ammonium compound agents and general methods of making them are disclosed in U.S. Pat. No. 4,137,180, which is herein incorporated by reference in its entirety.

In some embodiments, the quaternary ammonium compound is present in the treatment agent from about 0.1 wt % to about 20 wt %, or from about 0.5 wt % to about 20 wt %, or from about 0.5 wt % to about 15 wt %, or from about 1 wt % to about 15 wt %, based on the volume of the treatment agent.

In some embodiments, the quaternary ammonium compound is present in the band in an amount from about 0.5 g to about 5.0 g, or from about 1.0 g to about 5.0 g, or from about 1 g to about 4.5 g, or from about 2 g to about 4.5 g, or from about 3 g to about 5 g, or from about 3 g to about 4.5 g, based on the total weight of the band.

### Silicone

In one embodiment, the softening agent can be a silicone.

In some embodiments, the silicone can be a non-functionalized silicone such as polydimethylsiloxane (PDMS) or alkyl or alkoxy functional silicone, amino functionalised silicones, and/or anionic silicones, such as carboxyl functionalised silicone. In one embodiment, the silicone can include functionalized silicone or a silicone copolymer with one or more different types of functional groups, including amino, phenyl, polyether, acrylate, siliconhydride, carboxylic acid, and quaternized nitrogen, and others.

In some embodiments, the silicone can be in the form of a silicone emulsion. In one embodiment, the silicone particle size can be in the range of from about 1 nm to about 100 microns, or from about 10 nm to about 10 microns. The silicone can include microemulsions (particle size<150 nm), standard emulsions (particle size of about 200 nm to about 500 nm) and/or macroemulsions (particle size of about 1 micron to about 20 microns).

In some embodiments, the silicone is present in the treatment agent from about 0.1 wt % to about 20 wt %, or from about 0.5 wt % to about 20 wt %, or from about 0.5 wt % to about 15 wt %, or from about 1 wt % to about 15 wt %, based on the volume of the treatment agent.

In some embodiments, the silicone is present in the band in an amount from about 0.5 g to about 5.0 g, or from about 1.0 g to about 5.0 g, or from about 1 g to about 4.5 g, or from about 2 g to about 4.5 g, or from about 3 g to about 5 g, or from about 3 g to about 4.5 g, based on the total weight of the band.

### Anti-Static Agent(s)

In some embodiments, a single treatment agent can provide one of or both softening and anti-static benefits. In one embodiment, the softening and/or anti-static agent can be an ester quaternary ammonium compound including those already described herein.

### Additional Beneficial Agents

In some embodiments, the treatment agent of the present disclosure can include one or more additional beneficial agents. In certain embodiments, the one or more additional beneficial agent can be an anti-shrinking agent, an anti-wrinkling agent, ironing aids, an odor capturing agent, a fiber protection agent, a color protection agent, a soil releasing agent, an optical brightening agent, a UV protection agent, an anti-pilling agent, a water repellency agent, a disinfecting and/or sanitizing agent, a souring agent, a repellent, and mixtures thereof.

In some embodiments, the treatment agent can include an anti-wrinkling agent. In one embodiment, the anti-wrinkling agent can include a silicone, as disclosed herein with respect to other aspects of the invention, or a siloxane containing compound. In one embodiment, the anti-wrinkling agent can be a quaternary ammonium compound, as disclosed herein. Suitable anti-wrinkling agents include polydimethylsiloxane diquaternary ammonium that is available under the name Rewoquat SQ24 from DeGussa-Goldschmidt, silicone copolyol fatty quaternary ammonium that is available under the name Lube SCI-Q from Lambert Technologies, and polydimethyl siloxane with polyoxyalkylenes under the name Tinotex CMA from CIBA.

In some embodiments, the anti-wrinkling agent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the treatment agent can include an odor capturing agent. Suitable odor capturing agents include cyclodextrins and zinc ricinoleate.

In some embodiments, the odor capturing agent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the treatment agent can include a fiber protection agent. Suitable fiber protection agents include cellulosic polymers.

In some embodiments, the fiber protection agent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the treatment agent can include a color protection agent, e.g., a dye transfer inhibitor. Dye transfer inhibitors are typically used to prevent dye from dissolving or transferring to the wash liquor or other fabrics during washing and/or cleaning of dyed fabrics. Suitable dye transfer inhibitors include but are not limited to polymers or a copolymers of cyclic amines such as vinylpyrrolidone and/or vinylimidazole, polyvinylpyrrolidone (PVP), polyvinylimidazole (PVI), copolymers of vinylpyrrolidone and vinylimidazole (PVP/PVI), polyvinylpyridine-N-oxide, poly-N-carboxymethyl-4-vinylpyridium chloride and mixtures thereof. Additional suitable color protection agents include but are not limited to quaternary ammonium compounds such as di-(nortallow carboxyethyl) hydroxyethyl methyl ammonium methylsulfate that is available under the name Varisoft WE 21 CP from DeGussa-Goldschmidt, and surfactants. A suitable commercially available surfactant color protection agent is available under the name Varisoft CCS-1 from DeGussa-Goldschmidt. A suitable commercially available cationic polymer color protection agent is available under the name Tinofix CL from CIBA. Additional commercially available color protection agents suitable color protection agents include but are not limited to Color Care Additive DFC 9, Thiotan TR, Nylofixan P-Liquid, Polymer VRN, Cartaretin F-4, and Cartaretin F-23 from Clariant; EXP 3973 Polymer from Alco; and Coltide from Croda.

In some embodiments, the color protection agent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the treatment agent can include a soil releasing agent. Soil releasing polymers coat the fibers of fabrics to reduce the tendency of soils to attach to the fibers. Suitable commercially available soil releasing agents include but are not limited to Repel-O-Tex SRP6 and Repel-O-Tex PF594 from Rhodia, TexaCare 100 and TexaCare 240 from Clariant, and Sokalan HP22 from BASF.

In some embodiments, the soil releasing agent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the treatment agent can include an optical brightening agent. Optical brightening agents impart fluorescing compounds to fabrics. Suitable optical brighteners include stilbene derivatives (e.g., biphenyl derivative is distyryl biphenyl disulfonic acid sodium salt), biphenyl derivatives (e.g., cyanuric chloride/diaminostilbene disulfonic acid sodium salt), and coumarin derivatives (e.g., diethylamino coumarin). Suitable commercially available optical brighteners include but are not limited to Tinopal 5 BM-GX, Tinopal CBS-CL, Tinopal CBS-X, and Tinopal AMS-GX from CIBA.

In some embodiments, the optical brightening agent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the treatment agent can include a UV protection agent. A suitable commercially available UV protection agent includes Tinosorb FD from CIBA.

In some embodiments, the UV protection agent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the treatment agent can include an anti-pilling agent. Suitable commercially available anti-pilling agents include but are not limited to enzymes such as cellulase enzymes. Suitable commercially available cellulase enzyme anti-pilling agents are available under the names Puradex from Genencor and Endolase and Carezyme from Novozyme.

In some embodiments, the anti-pilling agent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the treatment agent can include a water repellency agent. Suitable water repellents include but are not limited to perfluoroacrylate copolymers, hydrocarbon waxes, and polysiloxanes.

In some embodiments, the water repellency agent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the treatment agent can include a disinfecting and/or sanitizing agent. Suitable sanitizing and/or disinfecting agents include but are not limited to quaternary ammonium compounds such as alkyl dimethylbenzyl ammonium chloride, alkyl dimethylethylbenzyl ammonium chloride, octyl decyldimethyl ammonium chloride, dioctyl dimethyl ammonium chloride, and didecyl dimethyl ammonium chloride.

In some embodiments, the disinfecting and/or sanitizing agent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the treatment agent can include a souring agent that neutralizes residual alkaline that may be present on the fabric. The souring agents can be used to control the pH of the fabric. Suitable souring agents include but are not limited to acids such as saturated fatty acids, dicarboxylic acids, and tricarboxylic acids, such as those that remain solid under conditions of operation in the dryer.

In some embodiments, the souring agent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

In some embodiments, the treatment agent can include repellents such as mosquito repellents. A suitable commercially available mosquito repellent is DEET.

In some embodiments, the repellent is present in the band in an amount from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

Additional suitable fabric treatment agents are disclosed in U.S. Pat. No. 7,456,145, which is herein incorporated by reference in its entirety.

The treatment agent may optionally contain further typical ingredients, for example those that improve the application-specific and/or aesthetic properties.

### Kits Comprising the Device

In some embodiments, kit may include one or more dryer balls (e.g., wool, plastic, or rubber) and one or more wraps, for example any of the wraps described herein, configured to be disposed around the one or more dryer balls. In some embodiments, the kit includes one or more wraps treated with a first treatment agent. In some embodiments, the kit further includes a container (e.g., a pour bottle, squirt bottle, spray bottle, etc.) confining a volume of a second treatment agent for disposing on the one or more wraps. This may be used, for example, to “re-charge” the wrap(s) with a treatment agent or add an additional treatment agent to the wrap. In some embodiments, the second treatment agent is different than the first treatment agent. In some embodiments, the second treatment agent is the same as the first treatment agent.

### Methods of Making a Wrap for Treating Textiles

Methods of making wraps for treating textiles are also contemplated. In some embodiments, a method of making a wrap for treating textiles in a dryer includes providing a substrate (e.g., any of the substrates disclosed herein) configured to be disposed around a dryer ball, and disposing a treatment agent on the substrate. In some embodiments, the treatment agent may be a fragrance, a softening agent, an anti-static agent, or any combination thereof. Specific treatment agents are disclosed herein. In an embodiment, the treatment agent is a liquid treatment agent. In an embodiment, the treatment agent is a gel treatment agent. In an embodiment, the treatment agent is encapsulated in a microcapsule, a nanocapsule, or any combination thereof.

In some embodiments, the method includes soaking the substrate (i.e., wrap) in a liquid or gel treatment agent. Typically, the wrap is soaked for a period of time sufficient to saturate the substrate with the treatment agent. This may allow the treatment agent to penetrate the material of the substrate. Generally, thereafter the wrap is allowed to completely dry before use. In some embodiments, the method includes rolling the substrate (i.e., wrap) in a liquid or gel treatment agent for a period of time sufficient to saturate the substrate with the liquid or gel treatment agent, and thereafter completely drying the substrate. In some embodiments, the method includes spraying a liquid or gel treatment agent onto the substrate (i.e., wrap) for a period of time sufficient to saturate the band with the liquid or gel treatment agent, and thereafter completely drying the substrate. In some embodiments, the method includes spraying an encapsulated treatment agent onto the substrate (i.e., wrap) for a period of time sufficient to saturate the band with the encapsulated treatment agent, and thereafter completely drying the substrate. In some embodiments, the method includes depositing an encapsulated treatment agent onto the substrate (i.e., wrap) for a period of time sufficient to cover the substrate with the treatment agent, and thereafter completely drying the substrate. In some embodiments, only an exterior surface of the wrap is coated with the treatment agent. In some embodiments, only one side of the wrap is coated with the treatment agent.

As mentioned above, in some embodiments, the method includes drying the substrate. Drying can be accomplished, for example, by drying the substrate at room temperature overnight, or by drying at elevated temperatures (i.e., in the range of about 20° C. to about 90° C.).

### Methods of Use

The devices of the present disclosure can be used to treat fabrics or textiles, for example, to impart softness, to impart scent (i.e., apply fragrance to), or decrease static build up when the treated textile is dried. In some embodiments, a method for treating a textile in a dryer includes disposing a wrap around a dryer ball, where the wrap is treated with a treatment agent. In some embodiments, the wrap (e.g., a wrap including elastic material) is stretched such so that it fits around the dryer ball. Generally, a tight fit around the dryer ball is desired such that the wrap remains around the dryer ball while tumbling in the dryer drum. In some embodiments, the method includes disposing the wrap around the dryer ball by attaching a first end of the wrap to a second end of the wrap, for example, by securing a fastener (e.g., hook-and-loop, clasp, snap, button, etc) as described herein.

In one embodiment, the method further includes loading the dryer ball and wrap into the dryer. In one embodiment, the method further includes running the dryer on a heated cycle. Without being bound by theory, it is thought that the treatment agent contained in the wrap melts, diffuses, etc. as the temperature during the drying cycle increases, such that the treatment agent disperses out of the wrap into the free space in the drum of the fabric-drying appliance, whereby the treatment agent is then deposited onto at least one fabric or textile during the heated drying cycle.

In one embodiment, the method further includes running the dryer on a non-heated (i.e., fluff) cycle. Without being bound by theory, it is thought that the treatment agent in the wrap physically transfers onto at least one fabric or textile during the non-heated drying cycle.

### EXAMPLES

The following materials and products were used in the Tables and examples set forth below.

Top loading traditional washing machines and electric tumble dryers capable of internal temperatures ranging from approximately 150° F.-160° F. were used for experiments. The test fabrics were 11″×11″ test pieces of 100% Dacron, 100% Cotton, Acetate Tricot, Poly/Cotton 65/35, Spun Nylon, Spun Orlon purchased from TestFabrics, West Pittston, Pa.

TABLE 1
Prototypes and Products for Softening and Static Tests

| Formula | Dosage |
|---|---|
| Detergent only | 1.56 oz/48.78 g |
| Detergent + Dryer Sheet | 1 Sheet |
| Detergent + Liquid Fabric | 1 wrapped dryer ball + |
| Softener Soaked band | 5 unwrapped dryer balls |
| Detergent + Quat on outside | 1 wrapped dryer ball + |
| surface of band | 5 unwrapped dryer balls |
| Detergent + Quat on inside | 1 wrapped dryer ball + |
| surface of band | 5 unwrapped dryer balls |
| Detergent + wool balls | 6 unwrapped dryer balls |
| (no band) | |
| Detergent + aluminum | 6 aluminum foil balls |
| foil balls | |

### Example 1

A softening test was designed to assess the softening effects on fabric samples after treatment of the fabrics with the device of the present disclosure.

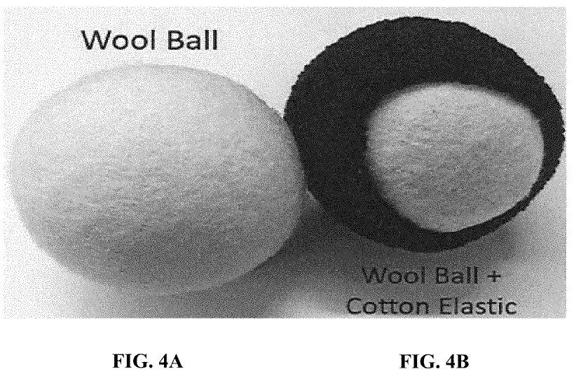

Three elastic bands were prepared as prototypes. Typical elastic wrist bands were used, as shown in FIG. 4B. The first band was soaked in liquid fabric softener and dried at room temperature overnight. The remaining two bands were coated with fabric softener dryer sheet active agent, Diethyl Ester Dimethyl Ammonium Chloride, by melting the active agent and evenly distributing drops of the active agent onto either the inside or the outside surface of the bands. Each of the test band prototypes were wrapped around a wool dryer ball and run through a test drying cycle with fabric samples, which samples included spun orion, poly/cotton, bleached cotton, spun nylon, dacron, and acetate tricot. For one band coated with fabric softener dryer sheet active agent, the active ingredient was facing outward such that the active ingredient was in contact with the fabrics in the dryer. For the other band coated with fabric softener dryer sheet active agent, the active ingredient was facing inward, such that the active ingredient was in contact with the wool dryer ball. A test drying cycle was run with aluminum foil balls. A test drying cycle was also was run with a fabric softener sheet as a performance benchmark. A control test drying cycle was run with fabrics treated with detergent only.

An Extraction Energy Test Method (EETM), using a Phabrometer instrument (Nu Cybertek, Davis, Ca), was employed to determine the softening effects of the above prototypes on the fabric samples. The results are shown in Table 2 below in descending order of the resulting softness from softest to harshest.

TABLE 2
Softening Results

| | Statistical | |
|---|---|---|
| | Category (i.e., | |
| | Levels of | Least |
| | Statistical | Square |
| Prototypes | Differences) | Mean |
| Detergent + Dryer Sheet | A | 90.393950 |
| Detergent + Quat on | B | 89.774683 |
| outside surface of band | | |
| Detergent + Liquid | B | 89.568492 |
| Fabric Softener Soaked | | |
| band | | |
| Detergent + Quat on | B | 89.507342 |
| inside surface of band | | |
| Detergent + unwrapped | C | 88.974525 |
| wool balls (no band) | | |
| Detergent + aluminum | C | 88.955983 |
| foil balls | | |
| Detergent only | C | 88.746742 |

The first column provides the prototype design and formula. The second column indicates the statistical category of the softness of the fabric sample. Fabric samples with single letters are statistically different from each other. The third column provides the softness score of the sample fabric as measured by the Phabrometer. Higher softness scores indicate softer samples.

As shown, samples washed with detergent and dried with a fabric softener sheet exhibited the highest softening performance according to the Phabrometer instrument. Fabric samples treated with detergent plus quat on the outside surface of the band, samples treated with detergent plus a liquid fabric softener soaked band, and samples treated with detergent plus quat on the inside surface of the band scored in the same statistical softness category. Each of these fabric samples were significantly softer than the fabric samples that were not treated with a liquid fabric softener or quat, but not as soft as the fabric samples dried with the dryer sheet. The samples treated with detergent and unwrapped wool dryer balls delivered the same softness as the detergent alone.

This example demonstrates that the addition of a device according to embodiments of the invention had a softening impact on the samples.

### Example 2

Anti-static tests using the Faraday Pail method were designed to assess the anti-static effects on fabric samples during after treatment of the fabrics with the devices of the present disclosure.

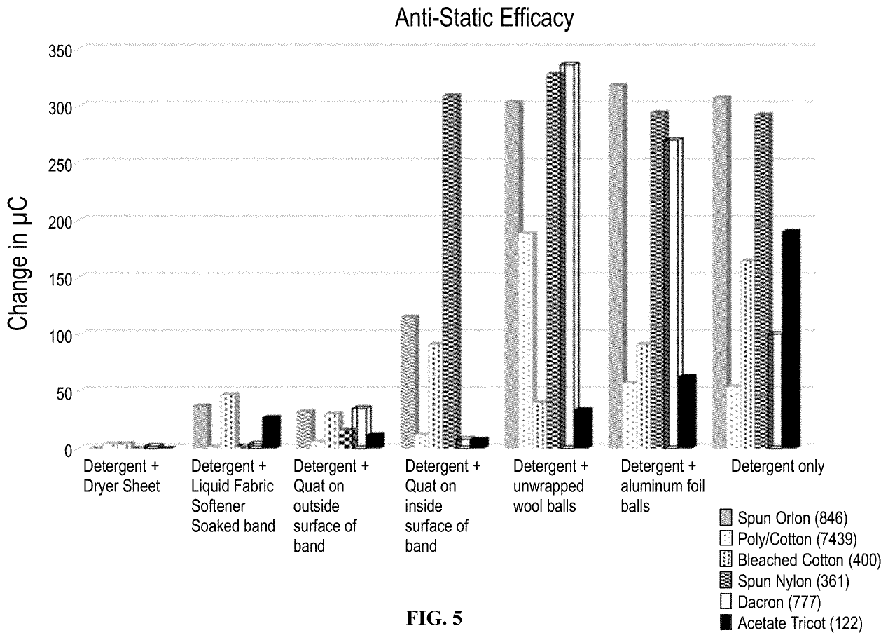

The anti-static efficacy of fabric samples treated with the device prototypes was evaluated by the Faraday Pail method (results shown in FIG. 5). This method is used measure the amount of static electricity generated on various fabric types during the course of tumble drying by measuring the ability for a treated textile to dissipate an imparted chart. An Imparted charge is electric charges that are transferred to fabric during tumble drying.

Briefly, test fabrics were prewashed to remove any residual finish or antistatic finish from the manufacturing process. A test location with less than 40% humidity was chosen and the ambient relative humidity was recorded. The interiors of the test dryers were cleaned with isopropanol to remove any accumulated dirt or product residue. Three replicate test fabric loads were prepared for each product to be evaluated as follows: one (1) piece of each of the test fabrics plus pieces of 50%/50% cotton/polyester ballast load to a total load weight of three (3) pounds. Experiment were run 3 times the dryers rotated between runs. Washed test loads were placed into the dryers and dried for sixty (60) minutes on a Timed Dry Cotton/Towels High cycle. A JCI 247 Faraday Pail (Dekra, Southampton, UK) was placed away from anything that may interfere with static readings, and the pail was set up, the JCI 178 charge measurement unit meter (Dekra, Southampton, UK) was charged and the equipment was grounded. Operator 1 stood on a rubber mat wearing rubber gloves. Operator 2 records the data and zeroes the charge meter between readings. After 45 minutes, the dryer is reset to 60 minutes again and the assessment steps below are taken. Operator 1 with rubber gloved hands, opened the first dryer and located the chosen colored fabric as quick as possible without touching the dryer door upon removal. The chosen fabric was removed, the dryer door closed, and the dryer was restarted. The fabric article was placed into the pail quickly without touching the rim. The charge indicated on the meter was recorded. The fabric article was then removed from the Faraday Pail and set aside and the meter was zeroed. The timer was then started for 5 minutes. Both operators then move onto the next dryer and locate the same colored fabric as chosen previously, and all of the dryers are continued for the next chosen colored fabric. After the 5 minutes had elapsed, the steps were repeated until all of the test fabric had been read. Each test fabric article for the 3 runs for each product tested was averaged and the data was plotted (FIG. 5) to determine performance differences. As shown, the three wool dryer balls wrapped with the treated elastic bands significantly reduced static in comparison to the untreated wool balls, the aluminum foil balls, and the drying test with no wool dryer balls.

### Example 3

Anti-static tests using the Field Meter method were designed to assess the anti-static effects on fabric samples after treatment of the fabrics with the devices of the present disclosure.

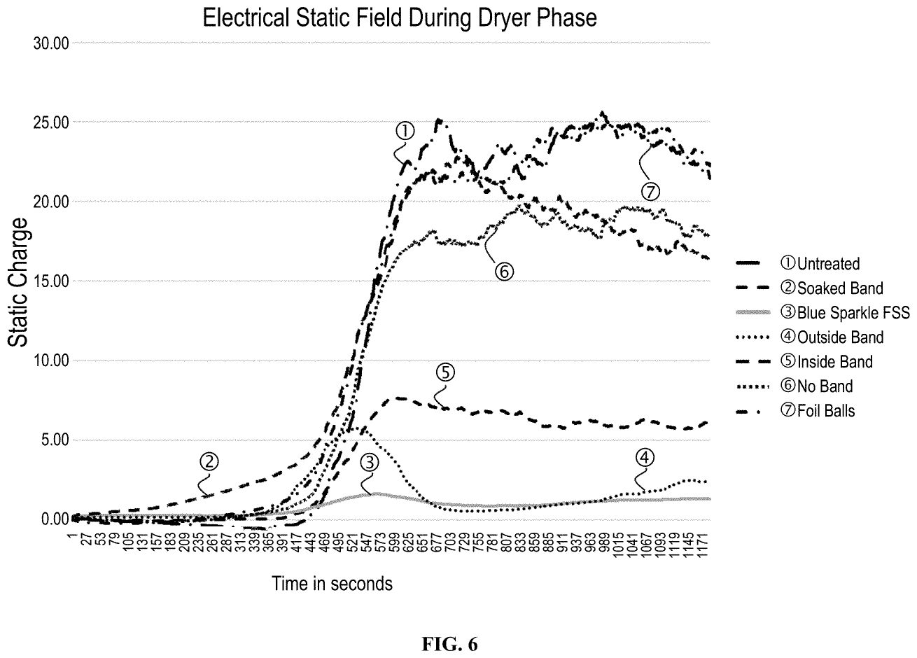

The JCI 140/F static monitor (Dekra, Southampton, UK) was used to measure the voltage of the test fabric surfaces. The meter was attached to the outside door of the dryer. Once the dryer was turned on the meter started to read the charges over the course of the drying cycle. The meter was attached to data logging software where the charges/second were recorded and then graphed. Lower results means there is lower static electricity in the fabrics. FIG. 6 shows the charge in μC at the end of the drying cycle on different fabrics measured with the JCI 140/F static monitor.

As shown in FIG. 6, the untreated wool dryer balls generated less static than the fabrics dried without the wool dryer balls. The aluminum foil balls did not reduce static. The prototype with the dryer sheet active ingredient on the inside surface of the band slowly reduced the static charge over time. The band with the dryer sheet active ingredient on the outside surface of the band performed best (i.e., reduced static electricity in the dryer at the fastest rate).

This example demonstrates that the device prototypes of the present disclosure lowered the static electricity of the fabric samples.

Having now fully described this invention, it will be understood by those of ordinary skill in the art that the same can be performed within a wide and equivalent range of conditions, formulations and other parameters without affecting the scope of the invention or any embodiment thereof. All patents, patent applications, and publications cited herein are fully incorporated by reference herein in their entirety.

The foregoing description of the specific embodiments has revealed the general nature of the invention such that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A wrap for treating textiles in a dryer, comprising:
a substrate configured to be disposed around a dryer ball; and
a treatment agent disposed on the substrate.

2. The wrap of claim 1, wherein the substrate comprises an elastic material.

3. The wrap of claim 1, wherein the substrate comprises a non woven material.

4. The wrap of claim 1, wherein the substrate comprises cotton, wool, polyester, nylon, elastane, rayon, acetate, acrylic, natural fibers, synthetic fibers, or combinations thereof.

5. The wrap of claim 1, wherein the substrate has a width of about 1 cm to about 15 CM.

6. The wrap of claim 1, wherein the substrate has a thickness of about 0.1 cm to about 1 cm.

7. The wrap of claim 1, wherein the substrate comprises a continuous band.

8. The wrap of claim 1, where the substrate has a circumference of about 5 cm to about 50 cm.

9. The wrap of claim 1, wherein the substrate comprises a first end and a second end, wherein the first end and the second end are configured to be releasably attached.

10. The wrap of claim 9, wherein one side of the substrate comprises a hook portion of a hook-and-loop fastener.

11. The wrap of claim 1, wherein the treatment agent is a liquid treatment agent.

12. The wrap of claim 1, wherein the treatment agent is a gel treatment agent.

13. The wrap of claim 1, wherein the treatment agent is encapsulated in a microcapsule, a nanocapsule, or any combination thereof.

14. The wrap of claim 1, wherein the treatment agent comprises a fragrance, an encapsulated fragrance, a softening agent, an anti-static agent, or any combination thereof.

15. The wrap of claim 14, wherein the fragrance is a fragrance precursor, a free fragrance, or a combination thereof;
wherein the fragrance is an ester, an ether, an aldehyde, a ketone, an alcohol, a hydrocarbon, an oil, an essential oil, a botanical, or any combination thereof;
wherein the fragrance is present in an amount of from about 0.1 g to about 8.0 g, or from about 0.5 g to about 7.0 g, or from about 1 g to about 6 g, or from about 2 g to about 5 g, or from about 3 g to about 5 g, or from about 4 g to about 5 g, based on the total weight of the band.

16. The wrap of claim 14, wherein the softening agent is a quaternary ammonium compound selected from the group consisting of: alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof; and
wherein the quaternary ammonium compound is present in an amount of from about 0.5 g to about 5.0 g, or from about 1.0 g to about 5.0 g, or from about 1 g to about 4.5 g, or from about 2 g to about 4.5 g, or from about 3 g to about 5 g, or from about 3 g to about 4.5 g, based on the total weight of the band.

17. The wrap of claim 14, wherein the softening agent is a silicone selected from the group consisting of: polydialkylsiloxanes, amino functionalised silicones, and anionic silicones; and
wherein the silicone is present in an amount of from about 0.5 g to about 5.0 g, or from about 1.0 g to about 5.0 g, or from about 1 g to about 4.5 g, or from about 2 g to about 4.5 g, or from about 3 g to about 5 g, or from about 3 g to about 4.5 g, based on the total weight of the band.

18. The wrap of claim 14, wherein the anti-static agent is a quaternary ammonium compound selected from the group consisting of: alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof; and
wherein the quaternary ammonium compound is present in an amount of from about 0.5 g to about 5.0 g, or from about 1.0 g to about 5.0 g, or from about 1 g to about 4.5 g, or from about 2 g to about 4.5 g, or from about 3 g to about 5 g, or from about 3 g to about 4.5 g, based on the total weight of the band.

19. The wrap of claim 1, further comprising an additional treatment agent selected from the group consisting of: an anti-wrinkling agent, an odor capturing agent, a fiber protection agent, a color protection agent, a soil releasing agent, an optical brightening agent, a UV protection agent, an anti-pilling agent, a water repellency agent, a disinfecting and/or sanitizing agent, a souring agent, a repellent, and mixtures thereof; and
wherein the at least one additional agent is present in an amount of from about 0.5 g to about 5.0 g, based on the total weight of the band.

20. The wrap of claim 1, wherein the treatment agent melts at a temperature of between about 35° C. to about 75° C.
